(19) United States
(12) Patent Application Publication
(10) Pub. No.: US 2025/0343430 A1
(43) Pub. Date: Nov. 6, 2025

(54) METHOD FOR CHARGING A BATTERY OF A DEVICE, DEVICE AND COMPUTER PROGRAM PRODUCT

(71) Applicant: Sivantos Pte. Ltd., Singapore (SG)

(72) Inventors: Heng Goh Yap, Singapore (SG); Chuan En Andrew Ong, Singapore (SG); Gee Heng Ler, Singapore (SG); Guan Hong Ng, Singapore (SG)

(21) Appl. No.: 18/652,189

(22) Filed: May 1, 2024

(51) Int. Cl. H02J 7/00; H01M 10/44; H04R 1/10

(52) U.S. Cl. CPC H02J 7/007182; H01M 10/446; H02J 7/0049; H04R 1/1025; H04R 2225/31

(57) ABSTRACT

A method charges a battery of a device. In the method an initial a battery fully charged voltage (BFCV) is set, which after completion of a charging phase yields a capacity less than a maximum capacity of the battery. In each of several charging phases the battery is charged until a charging voltage of the battery reaches a current BFCV. For a first of the charging phases the current BFCV is set to the initial BFCV. The current BFCV is increased after a last charging phase and for a next charging phase such that a minimum capacity of the battery is maintained. Furthermore, a corresponding device and computer program execute the method.

### FIELD AND BACKGROUND OF THE INVENTION

The invention concerns a method for charging a battery of a device, a device configured to carry out such a method and a computer program product for implementing the method in such a device.

Lithium-ion battery cell-powered devices are becoming ubiquitous in our daily lives. An example for such a device is a rechargeable hearing aid using the lithium-ion battery cell as the main energy source. These rechargeable hearing aids provide improved usability and convenience to the user by eliminating the need for regularly replacing the traditional zinc-air battery cells.

However, lithium-ion batteries, i.e., their cells, are subjected to degradation over time and usage and are usually not replaceable at the user's side. When such a battery degrades, its energy storage capacity is expected to reduce, leading to a reduced operation runtime for the device. This could result in an unsatisfactory user experience or, worse, a dead device with a non-functional battery. This is particularly problematic for hearing aids, which are used through the entire day and which are crucial for a user's interaction with his/her environment.

The main factors contributing to degradation of a battery are a) battery temperature, b) depth-of-discharge, and c) the battery's overcharging voltage.

The battery temperature during storage and charging can affect the lifespan of the battery. The additional external heat energy could energize the battery and its internal mechanisms, leading to higher charge or energy and causing higher degradation. It is advisable to state corresponding warnings in user manuals of rechargeable devices to keep the battery in a cool environment and out of direct sunlight during storage or charging processes.

Batteries that are subjected to lower depth-of-discharge (short: DoD, meaning the usage of capacity is less) can be expected to have a higher lifespan. The depth-of-discharge (DoD) refers to the amount of energy used or discharged. 100% DoD refers to a fully charged battery being discharged from 100% to 0% state-of-charge (SOC). However, it may not be practical to limit a user to a total amount of energy, which is equivalent to operation runtime, to increase battery lifespan. Especially in a hearing aid, a decrease of operation runtime may limit usability through the day.

The overcharging voltage to the battery could incur voltage stress, contributing to further degradation and capacity fading. To reduce capacity fading, the final charging SOC can be limited to a lower value. This can be practically implemented in hearing aids, but would result in limited capacity. A design dilemma occurs as the capacity fading mitigation effect increases when the capacity is further limited. Therefore, the user could experience a longer device lifespan while suffering from limited operation runtime or an underutilized battery.

In general, it is desirable to provide a charging method which prevents overcharging as well as undercharging and which optimizes the usable capacity of the rechargeable battery in a device.

Reference is made to the following patents and patent publications US 2014/0 320 089 A1, EP 4 099 475 A1, U.S. Pat. No. 10,620,243 B2, U.S. Pat. No. 10,701,492 B2, US 2006/0 256 989 A1, US 2020/0 260 195 A1, CN 108 183 525 B, JP 4 258 995 B2, U.S. Pat. Nos. 6,061,639, 9,537,342 B2, 10,286,789 B2, 11,670,952 B2, 11,703,548 B2, US 2019/0 044 345 A1, US 2022/0 146 590 A1.

### SUMMARY OF THE INVENTION

Against this background, it is an object of the present invention to improve battery charging. In particular, charging of a battery inside a mobile device shall be improved. To this end, an improved method for charging a battery of a device, a device configured to carry out the method and a computer program product implementing said method shall be presented.

One or several of the objectives mentioned in this application are solved by the subject matter as claimed in the claims and as described in the following text. Any statements with respect to the method correspondingly also apply to the device and computer program product and vice versa. Insofar as steps of the method are implicitly or explicitly described, advantageous embodiments of the device are derived by the device being configured to carry out one, several or all of these steps. To this end, the device preferably contains a suitable control unit, which is correspondingly configured to carry out said one, several or all steps.

The method is a method for charging a battery of a device. The method contains a step in which an initial battery fully charged voltage is set, which after completion of a charging phase yields a capacity less than a maximum capacity of the battery. In this application, the expression battery fully charged voltage is abbreviated as “BFCV”. The method also comprises that in each of several charging phases the battery is charged until a charging voltage of the battery reaches a current BFCV. In other words: at a particular charging phase, a certain target value for the BFCV to be used, i.e., the current BFCV, is provided and the battery is charged during this particular charging phase using said current BFCV. In subsequent charging phases different values may be used for the BFCV, i.e., the BFCV may vary. The method, then, contains a step in which for a first of the charging phases the current BFCV is set to the initial BFCV. For this first charging phase, the value of the current BFCV is identical to the pre-defined initial BFCV. The method further includes a step in which the current BFCV is increased after a last charging phase and for a next charging phase such that a minimum capacity of the battery is maintained. The last charging phase meaning that charging phase which precedes the next, i.e., upcoming charging phase. In this way, the BFCV used for a particular charging phase, i.e., the current BFCV, is the result of a continuous revision and adjustment of the BFCV for subsequent charging phases. The adjustment is such that a minimum capacity of the battery is maintained, which results in the current BFCV either being kept the same, i.e., using the BFCV of the last charging phase also as the BFCV for the next charging phase, or being increased, i.e., using a larger value for the BFCV in the next charging phase as compared to the last charging phase.

The device is a mobile device. However, the term “device” is used in the following for brevity. The device contains a control unit, e.g., a microcontroller, which controls the various components of the device and which manages the device's operation. The device or a charger used for charging said device comprises a charging controller, which—in the case of the device—is integrated into the control unit or separate therefrom. The combination of a device and charger is denoted as a “system”. The charging controller controls charging of the device's battery. In some embodiments, the charging controller also controls discharging of the battery during operation of the device. The device is either in a discharge phase or in a charging phase. During a discharging, phase energy from the battery is consumed to power the operation of the device. During a charging phase the device is connected (wired or wirelessly) to a charger which provides energy which is stored in the battery. Charging and discharging phases alternate. A discharging phase and a subsequent charging phase (or vice versa) constitute one cycle. During its lifetime, the device will experience many such cycles. In the following, only the operation with respect to the charging phase is described in detail, since the inventive method is primarily concerned with charging the device's battery during a charging phase.

During a particular charging phase, the device is connected to a charger for wireless or wire-bound energy transfer. The charging phase usually contains two subsequent stages, namely a first constant current stage and a second, variable current stage. During the constant current stage, the charger applies a constant voltage to the charging controller input with constant current flowing toward the battery at a steadily increasing battery voltage (in particular charging (input) voltage), until the BFCV is reached. During the constant voltage phase, then, the battery voltage is equal to the BFCV and the charger applies a similar constant voltage to the charging controller, as the current gradually declines towards 0, until the current is below a set threshold, e.g., of about 3% of initial constant charge current. The BFCV, therefore, crucially defines the charging behavior, in particular the full charged battery voltage of the charging behavior. The BFCV defines the battery voltage limit for a particular charging phase.

Preferably, the device is a hearing aid. Without loss of generality, it is assumed in the following, that the device is a hearing aid. While the invention is particularly adapted for and advantageous in a hearing aid, it may also be used in other devices with some advantage. Hence, the statements below with respect to a hearing aid also apply to a device in general.

A hearing aid generally has an input transducer, a signal processing unit and an output transducer. The input transducer is usually a microphone. The output transducer is usually an earpiece, which is also known as a loudspeaker or receiver. A hearing aid is usually assigned to a single user and is only used by that user. A hearing aid is used, for example, to improve hearing for a hearing-impaired user and to compensate for a hearing loss of said user (intended use). The input transducer generates an input signal which is fed to the signal processing unit. The signal processing unit modifies the input signal and thereby generates an output signal, which is therefore a modified input signal. To compensate for hearing loss, the input signal is amplified with a frequency-dependent amplification factor, for example according to the user's audiogram. The output signal is then output to the user via the output transducer. In the case of a hearing aid with a microphone and receiver, the microphone generates the input signal from sound signals in the environment and the receiver generates a sound signal from the output signal. The input signal and the output signal are electrical signals. In contrast, the sound signals from the environment and any sound signal emitted by the hearing aid are acoustic signals.

The battery is used during the intended use of the device to power its various components, e.g., the control unit, the signal processing unit, the input transducer, and the output transducer. The battery is a rechargeable energy storage medium, preferably a lithium secondary battery. The battery generally comprises one or more cells, which are electrically connected to each other in parallel or in series or a combination of both, to achieve distinct voltage and current from the battery. The number of cells also defines the battery's capacity. In the following, only the term “battery” is used for simplification and it is understood that any statements regarding the battery also apply to its one or more cells. In particular, the various parameters described in the following and with reference to the battery are defined by corresponding parameters of the battery's individual cells and their electrical connection, which may vary. Without loss of generality, it is assumed in the following that the battery comprises exactly one cell. However, the statements below also correspondingly apply to a battery with several cells.

Preferably, the current BFCV is increased for the next charging phase if an accumulated charge acquired during the last charging phase is lower than a pre-defined desired device capacity.

Preferably, the current BFCV is increased for the next charging phase if a start charging battery voltage of the last charging phase is lower than a pre-defined start charging battery voltage limit, and an end charging battery voltage of the last charging phase is larger or equal than the BFCV, and an accumulated charge acquired during the last charging phase is less than a pre-defined desired device capacity.

Preferably, a cycle count is increased every time a charging phase is completed, wherein the current BFCV is increased for the next charging phase, if the cycle count reaches one of a number of pre-defined cycle numbers.

Preferably, the cycle numbers are defined by a fixed cycle-count interval, such that the current BFCV is increased every time a fixed number of charging phases corresponding to the cycle-count interval is completed.

Preferably, a cycle count is increased every time a charging phase is completed, wherein the current BFCV is increased based on the current cycle count according to a look-up table.

Preferably, if the current BFCV is increased, it is increased by a pre-defined BFCV increment.

Preferably, increasing the current BFCV is limited to a pre-defined final BFCV.

Preferably, the device is a hearing aid and the battery is a secondary battery.

The invention acknowledges that a wireless charging process tends to have higher heat generation than a contact charging process. The heat generation of a wirelessly charging device is due to the exposure of a receiver of the device to a magnetic field that creates a current flow through a coil of the receiver. The current flow across the receiver coil is the major factor in heat generation. Possible solutions for temperature reduction in wireless charging are:
using a voltage doubler rectifier as the energy rectification circuit,
using an inverted load modulation and pulse modulation as a receiver information encoding mechanisms for communication,
an enhanced receiver system design with an appropriate selection of winding turns of the receiver coil and an appropriate selection of load modulation current amplitude, and
controlling a charging input voltage from the charger used to charge the device.

All these solutions effectively reduce the effect of additional external heat energy given to the battery by the action of reducing the overall current flow over the receiver coil. This eventually reduces the degradation of the battery, resulting in slower battery capacity fading and prolonging the battery lifespan.

For the prevention of battery deep discharging in the device, the charging controller suitably has a (first) protection module that switches off the device to disable further battery discharging when the battery voltage is lower than a discharging voltage limit. For example, a lithium battery has 0% SOC when the battery voltage is at 3.00V. The discharging voltage limit of the charging controller is 3.20V, which is about 0.5% SOC of a lithium battery cell. When the battery in the device discharges to 3.20V, the protection module implements a discharging disable feature (or charging controller switch off feature). The protection module is activated by the charging controller, resulting in that any current flowing out from the battery remains in the nano-Ampere (nA) range. Furthermore, it is preferred that another (second) protection module is placed between the battery and the charging controller in the device. The second protection module serves as a secondary protection and cuts off and isolates the battery from the charging controller by galvanic isolation. The aforementioned occurs when the battery's voltage is over-discharged to a protection cut-off voltage limit, for instance, 3.10V, which is about 0.2% SOC of a lithium battery cell.

For the mitigation of overcharging to the battery in the device, two suitable solutions are a) a constant low charging method and b) a smart charging method. The constant low charging method (full: constant low full battery voltage charging method) contains using a constant voltage that is lower than the specified BFCV as the current BFCV for any charging phase without any adjustments. This method gives less voltage stress to the battery over the entire charging phase of the device. The smart charging method also mitigates battery overcharging. During smart charging the current BFCV is continuously revised for the next charging phase. The revision of the BFCV for the next charging phase is based on the state of charge (SOC) usage or the battery voltage at the end of the discharging phase of the current cycle, i.e., the DoD, associated with the current BFCV of the current cycle. The DoD has an upper limit and a lower limit. In other words: The BFCV is revised based on the actual DoD after a discharging phase compared to an upper and a lower DoD limit. The BFCV also has an upper limit and a lower limit, and the BFCV is always kept within the range of the corresponding upper and lower limit. In the smart charging method the BFCV of the next charging phase is reduced to a lower value when the DoD of the current cycle is higher than the upper limit. Vice versa, the BFCV of the next cycle is increased to a higher value when the DoD of the current cycle is lower than the lower limit. The BFCV of the next cycle remains the same as in the current cycle if the DoD of the current cycle is within the range of the upper limit and the lower limit. In summary, smart charging is implemented with a charging algorithm that continuously revises the BFCV to a lower or higher value for the next cycle based on the user's daily battery capacity usage. As such, smart charging has a complex algorithm, which requires extra energy for the device to operate. Furthermore, smart charging prolongs the battery lifespan of a device only if the device is not in heavy use with the battery always fully depleted and if the device is not abused by charging only when the battery is fully depleted.

In short, undercharging may be prevented by cutting off the battery upon reaching a defined threshold voltage. Overcharging may be prevented by either the constant low method or the smart method. The present invention provides a different method, which is called “flat charging method”, which refers to maintaining a certain minimum capacity by suitable adjustments of the BFCV used in subsequent charging phases. In this application, three different embodiments for the flat charging method are described, namely a regular flat charging method, a linear flat charging method and a non-linear flat charging method.

### Flat Charging Method

The invention acknowledges that it is inevitable that the capacity of the battery degrades over time and drops below a certain limit (equivalent to a certain operation runtime), i.e., the battery's capacity for a given voltage degrades over time, e.g., from 100% to 80% at 4.2V and after 1000 cycles. According to the inventive flat charging method, the BFCV is initially (i.e., before first use and before the intended use of the device or before first charging) reduced and then gradually increased to obtain a constant capacity over time, i.e., over the device's lifetime. The initial reduction of the BFCV is achieved by setting the current BFCV for the first charging phase to the initial BFCV, which is lower than initially possible and, hence, only yields a reduced capacity (<100%). The invention is based on the observation, that 100% capacity is usually not necessary and, hence, no significant reduction in usability occurs by initially limiting the capacity to less than 100%. In particular, this is the case for a hearing aid, which is usually used through the day and charged during night. Also, in the flat charging method the battery is charged less aggressively and its lifetime is prolonged. The battery charging capacity and/or cycle are repeatedly monitored and the BFCV is adjusted when one or several specific criterions are fulfilled. In other words: By progressively increasing the BFCV, i.e., the charging (input) voltage limit of the battery with the flat charging method as presented here and when viewed over several cycles, the lifespan of the battery is effectively increased, and the battery degrades at a lower rate due to the lower voltage stress given to the battery. Also, the flat charging method advantageously extends the lifespan of a battery that underwent charging according to a typical full charging method as discussed above. When configured appropriately, the BFCV of the battery is adjusted according to the degradation of battery capacity, thereby ensuring that a given operation runtime requirement is always satisfied.

The inventive flat charging method is a method for charging a rechargeable (secondary) battery of a device, in particular a hearing aid. The flat charging method includes an initializing step of initially setting the BFCV to an initial BFCV which yields less than 100% capacity, i.e., an initial BFCV which is lower than is specified for this battery. The flat charging method further contains an adjustment step of increasing the BFCV every time a (one or several) pre-defined adjustment criterion (short: criterion) is fulfilled, i.e., met. Accordingly, the BFCV is adjusted to a higher value (level) after some time to compensate for the degradation of battery capacity during said time. The adjustment is made regularly, namely every time the adjustment criterion is met. The exact criterion for increasing the BFCV may vary, the important aspect is that the criterion is defined such that a pre-defined minimum capacity of the battery is maintained. In other words: The method starts with a low BFCV and increases the BFCV such that a certain minimum capacity is maintained. In effect, the flat charging method is a charging strategy that prolongs the lifespan of the battery in the device while maintaining sufficient device operation runtime.

The purpose of adjusting the BFCV to a higher level is to adjust the battery's fully charged capacity for the device to have sufficient operation runtime. The fully charged capacity is the maximum capacity the battery can be charged with. To be able to increase the BFCV over the device's lifetime, the BFCV is initially set to a low value, such that a later increase is possible. In other words, the BFCV is set to a low level at the initial charging cycle and then adjusted (or revised) to a higher level when the pre-defined adjustment criterion is fulfilled. The adjustment criterion is preferably be based on one or several of the following parameters: 1) the capacity of the fully charged battery, i.e., the fully charged capacity, or 2) the cycle count (equivalent: charging phase count), i.e., the total number of cycles already performed. The respective parameter is compared against a pre-defined threshold and the criterion is fulfilled, if the parameter reaches the threshold. As such, the flat charging method operates by increasing the BFCV when the capacity of the fully charged battery is insufficient, i.e., falls below a pre-defined threshold, or after a fixed cycle count interval, i.e., exceeds a pre-defined cycle count. A combination is also possible, where both criteria are checked and one or both criteria must be fulfilled for adjusting the BFCV.

The inventive increase of the BFCV is based on the observation that battery voltage and battery capacity vary with increasing cycle count. Since the battery naturally degrades over time and with prolonged use, the battery will have different capacities for the same level of battery voltage over time. The battery capacity drops to a lower value over time given the same battery voltage. For instance, at a battery voltage of 4.10V the capacity for a fresh battery is 90%, dropping to 80% after 1000 cycles of charging and discharging. In another example, a fresh battery at the 1st cycle has 100% battery capacity at 4.2V battery voltage, while at, e.g., the 1000th cycle the now degraded battery only has 80% capacity at 4.2V. This phenomenon is the basis for the invention described here, according to which the high initial battery capacity is deliberately sacrificed and a slightly lower capacity is initially used by setting the BFCV to a lower value than possible and, then, maintaining the device's desired capacity by increasing the BFCV value over time, e.g., time as indicated by the cycle count. As such, the term “flat charging” is meant to indicate a flat, i.e., constant or nearly constant battery's fully charged capacity over all cycles, instead of a constant battery voltage as in the constant low method as discussed above.

It has been observed that in a new device with a fresh battery the battery's capacity is usually not consumed entirely (100%) throughout a day. Therefore, it is possible to lower the BFCV and achieve a lower but still acceptable battery capacity, thereby reducing voltage stress on the battery. This prolongs the battery's lifespan, reduces degradation of the battery, and reduces capacity fading, resulting in a less steep gradient of capacity loss. At the same time, the inventive method adjusts the BFCV to maintain a certain battery capacity for satisfactory use.

The inventive method includes two subsequent stages, namely a preprocessing and an in-processing, wherein the in-processing follows the pre-processing. In particular, the in-processing is executed during the actual use of the device, i.e., while the device is used by a user as intended. The pre-processing, on the other hand, is executed as an initialization prior to the intended use of the device. The pre-processing is, e.g., executed during fabrication of the device or during initialization of the device at a technician's office prior to a first use by the designated user of the device. The initializing step is part of the pre-processing stage, while the adjustment step is part of the in-processing stage. In principle, the device may be reset and the preprocessing may be executed again, also followed by an in-processing, e.g., when refurbishing or repairing the device, in particular when exchanging its battery.

### Regular Flat Charging Method

In the following, preprocessing and in-processing are described for the regular flat charging method, but the statements generally apply mutatis mutandis to the linear and non-linear flat charging described further below.

### Preprocessing

The preprocessing preferably includes one, several or all of the following steps, which are preferably, but not necessarily, executed in the order as described:

In a first step a start charging battery voltage limit for a start charging battery voltage is set. The start charging battery voltage is the battery voltage at the beginning of a charging phase and the start charging battery voltage limit determines whether the adjustment of the BFCV according to the flat charging method does or does not take place (seventh step during in-processing, see below).

In a second step a desired capacity of the device is set. This ensures a certain minimum operation runtime, which corresponds to the desired capacity. The desired capacity is used during the in-processing to decide whether the BFCV should be adjusted or not in a given cycle. As an example, given an average battery consumption of 1.25 mA, a desired capacity of 20 mAh is equivalent to 16 hours of operation runtime, which is considered sufficient for a hearing aid. Preferably, the desired capacity is set such that the operation runtime is in the range of 10 to 20 hours.

In a third step an initial BFCV is set. In a fourth step a final BFCV is set. In a fifth step a BFCV increment is set. In a sixth step a current BFCV is set, the current BFCV (also “set BFCV” or “actual BFCV” or simply “BFCV”) is then used as BFCV during the next charging cycle, which is a first charging cycle of the device. With the third and fourth step the initial BFCV and the final BFCV are set. The initial BFCV is preferably set based on the battery's capacity and selected as a battery voltage that corresponds to a capacity of 80% to 90% of the fully charged capacity of a fresh battery (i.e., without degradation). The final BFCV is set to the full charging voltage level stated in the battery specification. The BFCV increment set in the fifth step is the increment value for adjusting the BFCV starting from the initial BFCV and approaching the final BFCV with each adjustment during in-processing (see below, eleventh and twelfth step). The BFCV increment preferably is in the range of 0.01V to 0.1V, depending on the desired resolution of the BFCV adjustment. A lower resolution, i.e., larger value for the BFCV increment, leads to a higher full charging battery capacity for the device, resulting in higher voltage stress on the battery, but with fewer iterations for adjusting the BFCV and, hence, less energy required for processing. Vice versa, a higher resolution, i.e., a smaller value for the BFCV increment, results in a larger number of iterations for adjusting the BFCV and more energy consumption for processing. On the other hand, the full charging battery capacity is less excessive. Finally, the pre-processing ends with setting the BFCV level to initial BFCV. The aforementioned settings resulting from the pre-processing are also denoted as “factory settings”.

The flat charging requires some parameters to be defined and set, which occurs during pre-processing and before beginning usage of the device during in-processing. At least the BFCV is continuously updated when certain criteria are met in the in-processing stage, as described below. In principle, also one or several of the other parameters set during pre-processing may be adjusted and, thus, re-set during in-processing. However, this is not required and it is assumed in the following that all parameters set during pre-processing and aside from the BFCV are kept unchanged during in-processing.

### In-Processing

When the device is used as intended, it enters the in-processing stage. Intended use of the device includes actual use by the user and corresponding discharging of the battery in a discharging phase as well as charging of the battery in a charging phase, during which the device is usually not actually used by the user, but left with a charger. Actual use of a hearing aid means that the hearing aid is worn by the user and the device consumes energy from the battery to process sound from the environment and a corresponding output of modified sound to the user.

The in-processing preferably includes one, several or all of the following steps (seventh to twelfth step), which are preferably, but not necessarily, executed in the order as described (for ease of reference, the numbering of the steps of the in-processing is continued from numbering used for the steps of the pre-processing).

In a seventh step (which is a first step of the in-processing) the start charging battery voltage is compared to the start charging battery voltage limit. This step is executed at the beginning of the charging phase of the current cycle, i.e., when charging is initialized. If the start charging battery voltage is equal or larger than the start charging battery voltage limit, no adjustment to the BFCV is made and no charging occurs. In the alternative, charging is always performed regardless of whether the start charging battery voltage is below the start charging battery voltage limit or not. Then, during the in processing it is only checked if the start charging battery voltage is below the start charging battery voltage limit. The operation returns to the seventh step for the next cycle. The seventh step is preferably repeated for each cycle. If, on the other hand, the start charging battery voltage is below the start charging battery voltage limit, charging is performed in an eight step and the charge accumulated during the eighth step is monitored and the corresponding value saved for later use (in the tenth step, see below). The start charging battery voltage being below the start charging battery voltage limit constitutes a first criterion for increasing the BFCV.

Following the charging in the eighth step, i.e., at the end of the current charging phase, two additional criteria (second criterion and third criterion) for increasing the BFCV are checked in a ninth step and a tenth step and the BFCV is only adjusted if both criteria are fulfilled. The first criterion is that the battery voltage at the end of the charging (end charging battery voltage) is equal or larger than the BFCV. Accordingly, the battery voltage at the end of the charging phase is compared to the current BFCV in a ninth step. If the battery voltage is not larger than the BFCV, no adjustment to the BFCV is made and the method continues with the seventh step. If, however, the battery voltage at least corresponds to the BFCV (second criterion), then the BFCV is increased, provided that all other criteria are also fulfilled. The third criterion, then, is that the accumulated charge is less than the desired device capacity (set in the second step). If the accumulated charge is equal or larger than the desired device capacity, then no adjustment is made to the BFCV and the method continues with the seventh step. If, however, the accumulated charge is smaller than the desired device capacity (third criterion), then the BFCV is increased, provided that all other criteria are also fulfilled. The second criterion ensures that the device has been fully and not only partially charged. The third criterion ensures, that an adjustment is only made when the accumulated charge, which-given that the second criterion is fulfilled-corresponds to the battery's fully charged capacity, is indeed smaller than the desired capacity, such that the BFCV should be increased for the next cycle. The ninth and tenth steps may be executed in any order or in parallel. Without loss of generality, it is assumed that the ninth step is performed first and the tenth step is only performed if the first criterion is fulfilled, such that the accumulated charge may be rightfully interpreted as the battery's fully charged capacity.

The seventh, eighth, ninth and tenth step as described above are particular to the regular flat charging. For linear and non-linear charging these steps are replaced by different steps achieving the same effect, namely, to increase the current BFCV after a last charging phase and for a next charging phase such that a minimum capacity of the battery is maintained.

If all three criteria mentioned above are fulfilled, an eleventh step is executed, in which the BFCV is adjusted by adding the BFCV increment (set in the sixth step). In other words: A new BFCV for the next cycle is derived from the current BFCV used in the current cycle by adding the BFCV increment to the current BFCV. In a twelfth step the BFCV is limited to the final BFCV (set in the fourth step). To do so, the BFCV is set to the final BFCV if the BFCV calculated in the eleventh step is larger than the final BFCV. After the eleventh step and the twelfth step, a discharging phase occurs and the method returns to the seventh step for the next charging phase.

By continuously monitoring the battery's fully charged capacity, the charging controller adaptively adjusts the BFCV when the accumulated charge is lower than the desired charge, to ensure sufficient operation runtime for the device. The following Table 1 illustrates an exemplary result of using the inventive flat charging method for charging a hearing aid with the following factory settings: BFCV increment=0.05V, initial BFCV=4.05V, final BFCV=4.20V, and desired charge=19 mAH. The battery cell in this example has a fully charged battery capacity of 26 mAh when fresh and at a fully charged voltage of 4.20V.

TABLE 1

| Cycle | Full Charging | Accumulated | |
|---|---|---|---|
| Count | Battery Voltage | Capacity | |
| 1 | 4.05 V | 22 | mAH |
| . . . | . . . | . . . | |
| 580 | 4.05 V | 18.9 | mAH |
| 581 | 4.10 V | 21.7 | mAH |
| . . . | . . . | . . . | |
| 1074 | 4.10 V | 18.9 | mAH |
| 1075 | 4.15 V | 22.2 | mAH |
| . . . | . . . | . . . | |
| 1628 | 4.15 V | 18.9 | mAH |
| 1629 | 4.20 V | 23.1 | mAH |

The example shows that the flat charging triggers a change in the BFCV when the accumulated capacity is less than the device's desired capacity of 19 mAh, which is the case at the 580th cycle, the 1074th cycle, and the 1628th cycle. The charging controller increases the BFCV with the BFCV increment for the next charging phase at the 581st cycle, 1075th cycle, and 1629th cycle. After the adjustment of the BFCV, the accumulated capacity is increased to a larger charging capacity than the desired capacity. Hence, the battery will be charged with more than the desired capacity during the next charging phase, as shown in Table 1.

The inventive flat charging method reduces the voltage stress on the battery during charging and eventually reduces fading of battery capacity, which prolongs the overall lifespan of the battery. As a consequence, the overall operation runtime of the device compared to typical full charging method is reduced, especially for the first cycles. A reduced operation runtime, however, is not a problem for a new device with a fresh battery because such a fresh battery is usually selected to have a capacity exceeding the capacity required for the use cases the device is designed for by about 10% to 30%. This excess capacity particularly enables the flat charging method described here. The adjustment of the BFCV to a higher voltage value is done to fulfill the operation runtime requirement as expressed by the desired capacity.

Further embodiments of the invention can be derived by variations of the embodiment described above. In the following, two further embodiments are explicitly described and referred to as “linear flat charging method” and “non-linear flat charging method”.

### Linear Flat Charging Method

Instead of monitoring the accumulated charge as described above in connection with the (regular) flat charging method, the cycle count may be monitored instead and the BFCV is, then, increased after a predefined number of cycles.

The cycle count is the number of cycles that has elapsed since the initial starting of the device. The cycle count is an integer that represents the number of completed cycles and, correspondingly the number of completed charging phases. Preferably, the cycle count is incremented by 1 only when the battery in the device has completed a charging phase to a pre-defined charging capacity level and/or has depleted during a discharging phase to a predefined capacity level. For example, only when the charging capacity is more than 50% or the charging phase lasted longer than 2 h is the charging phase considered complete and the cycle count is increased by 1.

The linear flat charging method adjusts the BFCV to a higher voltage value when the cycle count reaches pre-defined values which are equally spaced. In other words: A cycle count interval is set during pre-processing and the BFCV is increase every time the count number finishes the cycle count interval. For example, the cycle count interval is set to 365, which for a hearing aid corresponds to a year, since the hearing aid is charged daily. Hence, the BFCV will be increased after 365 days have elapsed, i.e., once each year.

In the preprocessing stage of the linear flat charging method, an initial BFCV and the final BFCV are set in a first and second step, respectively, the same as in the third and fourth step of the regular flat charging method. For example, the initial BFCV is set 4.05V, and the final BFCV is set to 4.20V. Also in the preprocessing stage a BFCV increment is set (corresponding to the fifth step of the regular flat charging method) to be used in the in-processing stage to adjust the BFCV. In an advantageous embodiment this is realized in a third and fourth step of the pre-processing: In the third step a number of levels of the BFCV between the initial and final BFCV is set. For example, four levels are set, which are 4.05V, 4.10V, 4.15V, and 4.20V. Then, in the fourth step the BFCV increment is calculated based on the levels, the final BFCV and the initial BFCV and set accordingly. In the present example the BFCV increment is calculated as and set to 0.05V. The third and fourth step may also be reversed such that a BFCV increment is chose and the levels are calculated based on the BFCV increment as well as the initial and final BFCV. Also, the BFCV increment may simply be set, e.g., as part of an initial setting performed during manufacture.

In a fifth step, the cycle count interval for adjusting the BFCV is set. The cycle count interval is preferably calculated from a lifespan requirement of the device and an assumed average cycle number per unit time. For example, a 3-year lifespan requirement yields 1095 cycles over the entire lifespan, assuming one cycle and, correspondingly, one charging phase per day. This results in a cycle count interval of 365. In a sixth step, a counter indicating the cycle count interval number is set to an initial value of 1. The counter, then, corresponds to the number of elapsed cycle count intervals plus 1 and, thereby, indicates the number of the current cycle count interval as well as the BFCV level number currently used. However, this is just an example and the counter and how it counts the cycle count intervals may defined differently in other embodiments of the invention. Given the example here together with the other exemplary settings mentioned above yields the BFCV adjustment as described in the following Table 2:

TABLE 2

| Cycle count | | Battery full |
|---|---|---|
| interval number/ | | charging |
| BFCV level number | Cycle count | voltage |
| 1 | 0-365 | 4.05 V |
| 2 | 366-730 | 4.10 V |
| 3 | 731-1095 | 4.15 V |
| 4 | ≥1096 | 4.20 V |

The first to sixth step of the preprocessing of the linear flat charging method as described above can be executed in any order.

In the example of Table 2 above, the BFCV during the in-processing is increased in steps of 0.05V, corresponding to the BFCV increment. Four such adjustments are made, namely one adjustment after every cycle count interval of 365. In this way, the BFCV is adjusted stepwise starting from the initial BFCV of 4.05V to the final BFCV of 4.5V.

During the in-processing stage the cycle count is monitored, in particular by the charging controller. The BFCV remains unchanged while the cycle count is within the cycle count interval. The BFCV is only adjusted if the cycle count corresponds to the cycle count interval, i.e., if the cycle count divided by the cycle count interval yields an integer value. In addition, it is preferable that the BFCV remains unchanged regardless of the cycle count, once the cycle count reaches a saturation cycle count, which corresponds to an expected lifetime of the device, i.e., 3 years are already mentioned above. In the example described here, the saturation cycle count is 1096, which is calculated via ((k−1)×cycle count interval)+1=((4−1)×365)+1=1096, wherein k is the cycle count interval number, corresponding to the BFCV level number.

In an advantageous embodiment the in-processing of the linear flat charging method is realized with the seventh to eleventh step as described in the following. In the seventh step, which is a first step of the in-processing, the BFCV is set based on the initial BFCV, which serves as an offset, and the cycle count interval number as well as the BFCV increment. In an eighth step, the cycle count is monitored and increased every time a charging phase is completed, wherein the criterion for considering a charging phase as complete is preferably the same as already mentioned above. In the ninth step, the cycle count is compared to the cycle count interval. If the cycle count is larger than the cycle count interval times the cycle count interval number, then, in a tenth step, the cycle count interval number is increased by 1. Otherwise, the method continues with the eighth step and the BFCV is not increased for the next charging phase. Increasing the cycle count interval number in the tenth step every time the cycle count corresponds to the cycle count interval effectively increases the BFCV due to the cycle count interval number being used for calculating the BFCV in the seventh step. In an eleventh step, then, an optional limitation of the BFCV occurs by maintaining the cycle count interval number at the pre-defined number of levels, corresponding to a maximum cycle count interval number.

The linear flat charging method shares the advantages of the regular flat charging method described further above. Additionally, the linear flat charging method has the advantage of a simpler operation during the in-processing stage when compared to the regular linear charging method, since only a single criterion, namely the cycle count in relation to the cycle count interval, has to be checked for deciding whether to adjust or maintain the BFCV for the next charging phase.

### Non-Linear Flat Charging

The linear flat charging method can be further modified by not setting a fixed number for the cycle count interval and/or for the BFCV increment. Instead, a different mapping of the cycle count to the BFCV is chosen. While the fixed cycle count interval and the fixed BFCV increment yield a linear behavior of adjusting the BFCV, any deviation from this yields a non-linear behavior. Hence, the corresponding method is denoted as non-linear charging method. The cycle counts for which the BFCV is adjusted and/or the BFCV increment used for the adjustment vary from adjustment to adjustment and, in principle, can be set to any value. In an advantageous embodiment, a mapping of the cycle count to a specific BFCV or BFCV increment is provided as a lookup table, in which a specific BFCV or BFCV increment is given for each of a number of cycle counts. During in-processing, once the cycle count reaches a cycle count from the look-up table the corresponding BFCV or BFCV increment is used to adjust the BFCV accordingly.

In principle, the non-linear flat charging method shares the advantages of the linear charging method and has the additional advantage of providing more flexibility to the device developer to set the cycle count and the respective BFCV. A disadvantage of the non-linear flat charging method compared to the other two methods described above is that it requires more memory to save the pre-defined mapping. The difference between the non-linear flat charging method compared to the linear flat charging method essentially is in the preprocessing stage, while the in-processing stage may be almost identical. The only difference during in-processing is in the seventh step, in which in the non-linear charging method the BFCV is simply compared to the BFCV mapped to the current cycle, e.g., as defined in the lookup table. For example, if the battery is predicted to have insufficient operation runtime after 550 cycles, then the 551st cycle is mapped to a larger BFCV in a mapping stored in a pre-processing memory of the device. Then, the BFCV would be adjusted at the 551st cycle to the corresponding larger BFCV, thereby ensuring sufficient capacity and providing the desired operation runtime to the user. The mapping may assign a respective BFCV to each or only some cycles.

As the battery's capacity performance may potentially be predicted over many cycles during the design stage of the device, the device developer has the flexibility to set the BFCV and the respective cycle count to the charging controller. Then, the charging controller keeps track of the cycle count during the various charging and discharging phases and changes the BFCV accordingly. In general, if an adjustment is made, the BFCV is preferably only increased, although a decrease is, in principle, possible.

In a suitable embodiment, the non-linear flat charging method includes a first step, in which a look-up table as described is provided. The look-up table maps cycle count numbers to a respective BFCV or BFCV increment. In a second step, the cycle count used during in-processing to monitor the number of elapsed cycles or cycle intervals is set to 1. The first and second step are part of the preprocessing of the non-linear flat charging method. During the subsequent in-processing stage, the look-up table is used to increase the BFCV in order to maintain a desired minimum capacity. The method then comprises a third, fourth, fifth and sixth step, corresponding to the eighth, ninth, tenth and eleventh step as discussed above in connection with the linear flat charging method. However, the fifth step is slightly different in that the cycle count is compared against the cycle count numbers in the look-up table. If the current cycle count number is present in the look-up table, the corresponding BFCV or BFCV increment is used. This may be achieved by comparing the cycle count against the cycle count numbers in the look-up table and using the last BFCV or BFCV increment for which the cycle count is larger than the corresponding cycle count number.

### Comparison of Flat Charging, Constant Low Charging and Smart Charging

In the following, a comparison is provided between the advantages and disadvantages of the inventive flat charging method, a constant low method and a smart charging method. The constant low full charging voltage method involves setting the current BFCV to a lower voltage than the BFCV as stated in the battery's specification and keeping it constant regardless of usage cycle or behavior. The smart charging method continuously adjusts the battery voltage/SOC at the end of the discharging phase for every cycle. The flat charging method increases the BFCV specifically if the battery capacity is insufficient (which can be determined in various ways). The constant low method has the advantage of not requiring extra computational effort to process adjustments on the BFCV. The smart charging method has the advantage of adjusting the BFCV based on user usage behavior. The flat charging method has the advantage of adjusting the BFCV based on the required battery capacity. All three concepts share the common advantage of prolonging the battery's lifespan. The constant low method has the disadvantage of sacrificing operation runtime at all times. The smart charging method has the disadvantages of requiring high computational power to process adjustments of the fully charged battery voltage for every cycle and is easily prone to user abuse, leading to a lower impact on prolonging the battery's lifespan. The flat charging method has the disadvantage of requiring additional computational power, but only when pre-defined criterion for triggering an adjustment of the BFCV is met.

### BRIEF DESCRIPTION OF THE FIGURES

FIG. 1 is an illustration of a device with a rechargeable battery and a charger according to the invention;

FIG. 2 is an illustration of a charging/discharging operation of the device in FIG. 1;

FIG. 3 is a flow chart of a smart charging method according to the prior art;

FIG. 4 is a flow chart of a regular flat charging method according to the invention;

FIG. 5 is a flow chart showing a linear flat charging method;

FIG. 6 is a flow chart of a non-linear flat charging method;

FIG. 7 is a chart showing a battery life cycle plot of a full charging method according to the prior art; and

FIG. 8 is a chart showing a battery life cycle plot of a linear flat charging method.

### DETAILED DESCRIPTION OF THE INVENTION

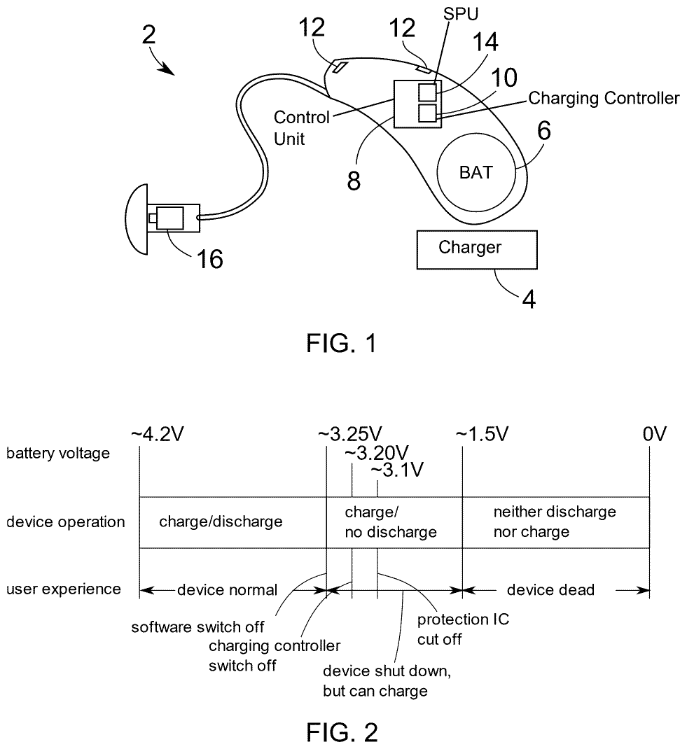

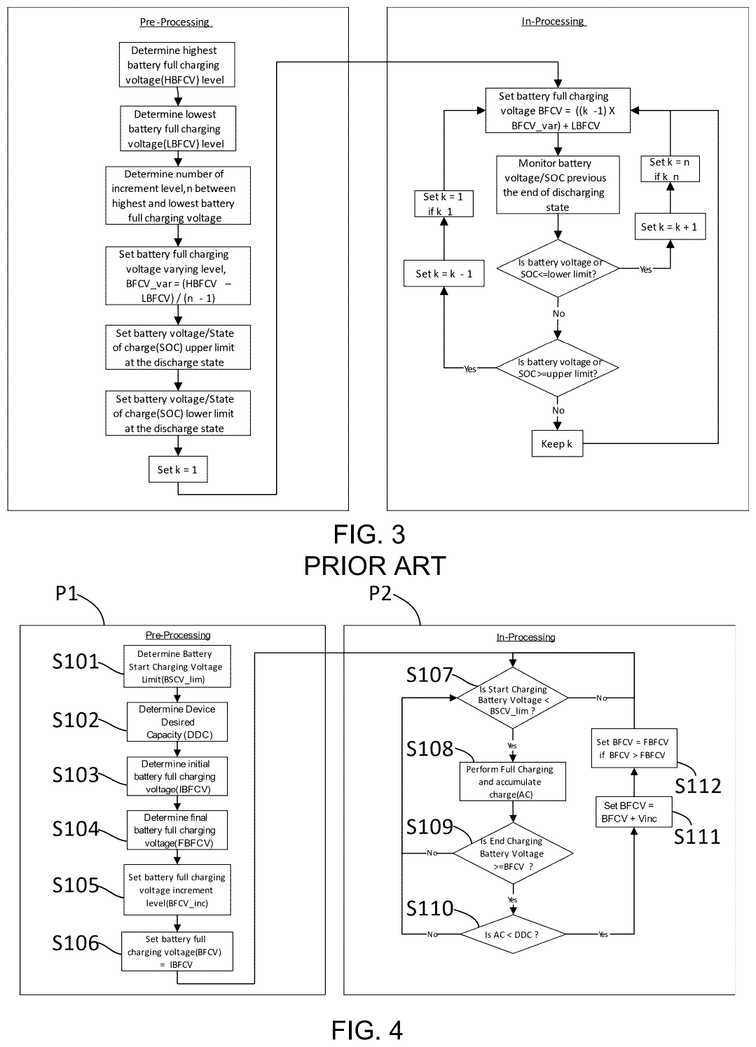

Referring now to the figures of the drawings in detail and first, particularly to FIG. 1 thereof, there is shown an embodiment for an inventive device 2, here a hearing aid, is shown in FIG. 1 together with a charger 4. Various embodiments of the inventive method are shown in FIGS. 4, 5 and 6. The method is a method for charging a battery 6 of the device 2. First an initial battery fully charged voltage IBFCV is set (steps S103, S201, S301), which after completion of a charging phase yields a capacity less than a maximum capacity of the battery 6. Then, in each of several charging phases, the battery 6 is charged until a charging voltage of the battery reaches a current BFCV, which is denoted in the figures simply as BFCV. Further, for a first of the charging phases the current BFCV is set to the IBFCV (steps S106, S207, S302). For this first charging phase, the value of the current BFCV is identical to the pre-defined IBFCV. A central aspect of the method now is that the current BFCV is increased after a last charging phase and for a next charging phase such that a minimum capacity of the battery 6 is maintained (steps S108-S111 in FIG. 1, steps S207-S210 in FIG. 2, steps S303-S306 in FIG. 3).

The device 2 is a mobile device and contains a control unit 8, e.g., a microcontroller, which controls the various components of the device 2 and which manages the device's 2 operation. The device 2 or the charger 4 contains a charging controller 10, which may be integrated into the control unit 8 or separate therefrom. The charging controller 10 controls charging of the device's battery 6. The device 2 is either in a discharge phase or in a charging phase. During a discharging phase energy from the battery 6 is consumed to power the operation of the device 2. During a charging phase the device 2 is connected (wired or wirelessly) to the charger 4 which provides energy which is stored in the battery 6. Charging and discharging phases alternate. A discharging phase and a subsequent charging phase (or vice versa) constitute one cycle. During its lifetime, the device 2 will experience many such cycles.

The device 2 shown in FIG. 1 is a hearing aid. However, the concepts described here may also be used in other devices. A hearing aid generally has an input transducer 12, a signal processing unit 14 and an output transducer 16. The input transducer 12 is usually a microphone. The output transducer 16 is usually an earpiece, which is also known as a loudspeaker or receiver. The hearing aid is used to improve hearing for a hearing-impaired user and to compensate for a hearing loss of said user (intended use). The input transducer 12 generates an input signal which is fed to the signal processing unit 14. The signal processing unit 14 modifies the input signal and thereby generates an output signal, which is therefore a modified input signal. To compensate for hearing loss, the input signal is amplified with a frequency-dependent amplification factor. The output signal is then output to the user via the output transducer 16.

The battery 6 is used during the intended use of the device 2 to power its various components, e.g., the control unit 8, the signal processing unit 14, the input transducer 12, and the output transducer 16. The battery 6 is a rechargeable energy storage medium, here a lithium secondary battery. The battery 6 comprises one or more cells, which are electrically connected to each other in parallel or in series or a combination of both, to achieve distinct voltage and current. In the following, only the term “battery” is used for simplification.

In the embodiment of FIG. 4, the current BFCV is increased for the next charging phase if an accumulated charge AC acquired during the last charging phase is lower than a predefined desired device capacity DDC. More specifically, in the embodiment of FIG. 4, the current BFCV is increased for the next charging phase if a start charging battery voltage of the last charging phase is lower than a predefined start charging battery voltage limit BSCV_lim, and an end charging battery voltage of the last charging phase is larger or equal than the BFCV, and the accumulated charge AC acquired during the last charging phase is less than the pre-defined desired device capacity DDC.

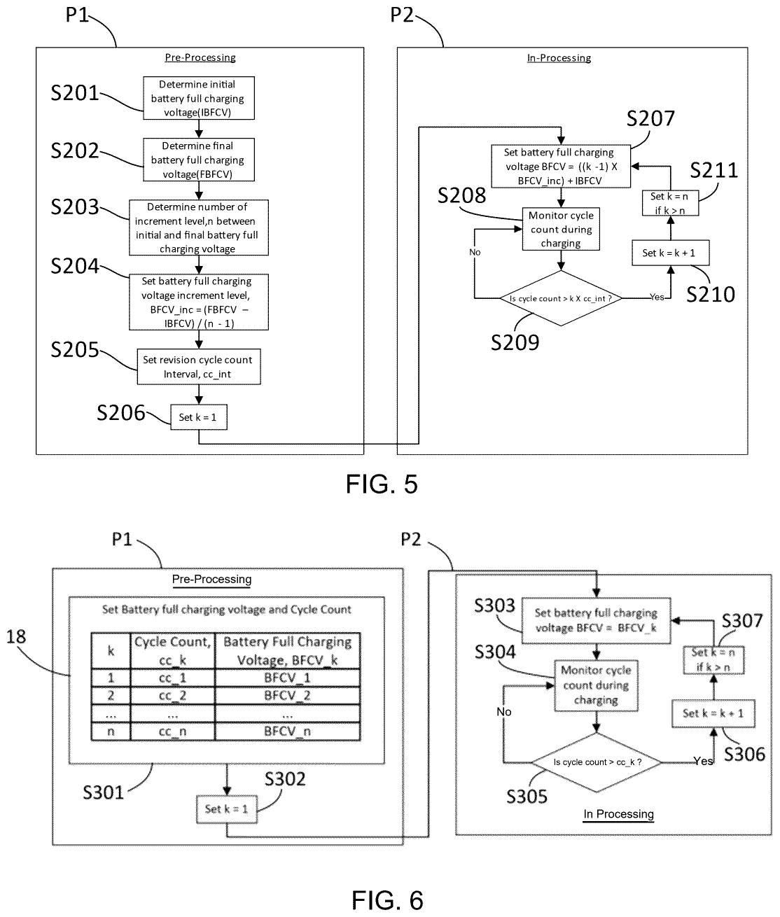

In the embodiments of FIGS. 5 and 6, a cycle count is increased every time a charging phase is completed and the current BFCV is increased for the next charging phase, if the cycle count reaches one of a number of pre-defined cycle numbers as defined by a cycle count interval cc_int. In other words, the cycle numbers are defined by a fixed cycle-count interval cc_int, such that the current BFCV is increased every time a fixed number of charging phases corresponding to the cycle-count interval cc_int is completed, as illustrated by the check performed in steps S209 and S305. In the particular embodiment shown in FIG. 6, the current BFCV is increased based on the current cycle count according to a look-up table 18, e.g., as defined in step S301. The current BFCV is increased by a predefined BFCV increment BFCV_inc, e.g., as defined in step S204 or as predetermined by the look-up table 18 in step S301.

Generally, increasing the current BFCV is limited to a pre-defined final battery fully charged voltage FBFCV, which is directly defined in steps S104 and S202 or indirectly defined by the last entry in the look-up table 18. The actual limiting occurs in steps S112, S211 and S307.

FIG. 2 illustrates a possible charging-discharging operation of the device 2 over different battery voltage ranges. For the prevention of battery deep discharging in the device 2, the charging controller 10 has a first protection module (charging controller switch off) that switches off the device 2 to disable further battery discharging when the battery voltage is lower than a discharging voltage limit. In the example shown here, the lithium battery has 0% SOC when the battery voltage is at 3.00 V. The discharging voltage limit of the charging controller 10 is 3.20 V, which is about 0.5% SOC of a lithium battery cell. When the battery 6 in the device 2 discharges to 3.20V, the protection module implements a discharging disable feature (or charging controller switch off feature). The protection module is activated by the charging controller 10, resulting in that any current flowing out from the battery 6 remains in the nano-Ampere range. In addition, a second protection module (protection IC cut off) is placed between the battery 6 and the charging controller 10 in the device 2. The second protection module serves as a secondary protection and cuts off and isolates the battery 6 from the charging controller 10 by galvanic isolation. The aforementioned occurs when the battery's voltage is over-discharged to a protection cut-off voltage limit, presently, 3.10 V, which is about 0.2% SOC of a lithium battery cell.

For the mitigation of overcharging to the battery in the device, two suitable solutions are a) a constant low charging method and b) a smart charging method. The constant low charging method (full: constant low full battery voltage charging method) includes using a constant voltage that is lower than the specified BFCV as the current BFCV for any charging phase without any adjustments. An example for a smart charging method is shown in FIG. 3 for comparison to the inventive methods of FIGS. 4, 5 and 6. During smart charging the current BFCV is continuously revised for the next charging phase based on the state of charge (SOC) usage or the battery voltage at the end of the discharging phase of the current cycle, i.e., the DoD, associated with the current BFCV of the current cycle. The DoD has an upper limit and a lower limit. The BFCV also has an upper limit and a lower limit, and the BFCV is always kept within the range of the corresponding upper and lower limit. In the smart charging method the BFCV of the next charging phase is reduced to a lower value when the DoD of the current cycle is higher than the upper limit. Vice versa, the BFCV of the next cycle is increased to a higher value when the DoD of the current cycle is lower than the lower limit. The BFCV of the next cycle remains the same as in the current cycle if the DoD of the current cycle is within the range of the upper limit and the lower limit.

The present invention provides a method, which is called “flat charging method”, which refers to maintaining a certain minimum capacity by suitable adjustments of the BFCV used in subsequent charging phases. Three different embodiments for the flat charging method are described here, namely a regular flat charging method (FIG. 4), a linear flat charging method (FIG. 5) and a non-linear flat charging method (FIG. 6).

According to the inventive flat charging method, the BFCV is initially reduced and then gradually increased to obtain a constant capacity over time as already described above. The initial reduction of the BFCV is achieved by setting the BFCV for the first charging phase to the IBFCV, which is lower than initially possible and, hence, only yields a reduced capacity (<100%). The battery charging capacity and/or cycle are repeatedly monitored and the BFCV is adjusted when one or several specific criterions are fulfilled. The criteria differ in detail, but are generally chosen such that they correlate with the capacity and indicate that said capacity falls below a minimum capacity, i.e., a desired device capacity. When designed appropriately and as described here, the BFCV of the battery is adjusted according to the degradation of battery capacity, thereby ensuring that a given operation runtime requirement is always satisfied. The method starts with a low BFCV and progressively increases the BFCV as needed such that a certain minimum capacity is maintained. The purpose of adjusting the BFCV to a higher level is to adjust the battery's 6 fully charged capacity for the device 2 to have sufficient operation runtime. The fully charged capacity is the maximum capacity the battery 6 can be charged with. To be able to increase the BFCV over the device's 2 lifetime, the BFCV is initially set to a low value, such that a later increase is possible and when a pre-defined adjustment criterion is fulfilled. The adjustment criterion is based on one or several of the following parameters: 1) the capacity of the fully charged battery 6, i.e., the fully charged capacity, as monitored in step S108, or 2) the cycle count (equivalent: charging phase count), i.e., the total number of cycles already performed, as monitored in steps S208 and S304. The respective parameter is compared against a pre-defined threshold in steps S110, S209 and S305 and the criterion is fulfilled, if the parameter reaches the threshold. As such, the flat charging method operates by increasing the BFCV when the capacity of the fully charged battery is insufficient, i.e., falls below a pre-defined threshold (FIG. 4), or after a fixed cycle count interval cc_int, i.e., exceeds a pre-defined cycle count cc_int (FIGS. 5 and 6). A combination is also possible, where both criteria are checked and one or both criteria must be fulfilled for adjusting the BFCV (not shown).

The inventive method comprises two subsequent stages, namely a pre-processing P1 and an in-processing P2, wherein the in-processing P1 follows the pre-processing P2. The in-processing P2 is executed during the actual use of the device 2. The pre-processing P1, on the other hand, is executed as an initialization prior to the intended use of the device 2.

Referring to FIG. 4, in a first step S101 the start charging battery voltage limit BSCV_lim for a start charging battery voltage is set. The start charging battery voltage is the battery voltage at the beginning of a charging phase and the start charging battery voltage limit BSCV_lim determines whether the adjustment of the BFCV according to the flat charging method does or does not take place (seventh step S107 during in-processing P2, see below).

In a second step S102 the desired capacity DDC of the device 2 is set. This ensures a certain minimum operation runtime, which corresponds to the desired capacity DDC. The desired capacity DDC is used during the in-processing P2 to decide whether the BFCV should be adjusted or not in a given cycle.

In a third step S103 the IBFCV is set and in a fourth step S104 the FBFCV is set. In a fifth step S105 the BFCV increment BFCV_inc is set. In a sixth step S106 the current BFCV is set and the current BFCV (also “set BFCV” or “actual BFCV” or simply “BFCV”) is then used as BFCV during the next charging cycle, which is a first charging cycle of the device 2. With the third and fourth step S103, S104 the IBFCV and the FBFCV are set. In FIG. 4, the IBFCV is set based on the battery's capacity and selected as a battery voltage that corresponds to a capacity of 80% to 90% of the fully charged capacity of a fresh battery 6 (i.e., without degradation). The FBFCV is set to the full charging voltage level stated in the battery specification. The BFCV increment BFCV_inc set in the fifth step S105 is the increment value for adjusting the BFCV starting from the IBFCV and approaching the FBFCV with each adjustment during in-processing P2 (see below, eleventh and twelfth step S111 and S112).

When the device 2 is used as intended, it enters the in-processing stage P2. Intended use of the device 2 includes actual use by the user and corresponding discharging of the battery 6 in a discharging phase as well as charging of the battery 6 in a charging phase, during which the device 2 is usually not actually used by the user, but left with the charger 4.

Again referring to FIG. 4, in the in-processing P2 a seventh step S107 in which the start charging battery voltage is compared to the start charging battery voltage limit BSCV_lim. This step S107 is executed at the beginning of the charging phase of the current cycle, i.e., when charging is initialized. If the start charging battery voltage is equal or larger than the start charging battery voltage limit BSCV_lim, no adjustment to the BFCV is made. The operation returns to the seventh step S107 for the next cycle. The seventh step S107 is repeated for each cycle. If, on the other hand, the start charging battery voltage is below the start charging battery voltage limit BSCV_lim, charging is performed in an eight step S108 and the charge AC accumulated during this eight step S108 is monitored and the corresponding value saved for later use (namely in the tenth step S110, see below).

Following the charging in the eight step S108 two additional criteria (second criterion and third criterion) for increasing the BFCV are checked in FIG. 4 in a ninth step S109 and a tenth step S110 and the BFCV is only adjusted if both criteria are fulfilled. The first criterion, which is checked in step S109, is that the battery voltage at the end of the charging (the end charging battery voltage) is equal or larger than the BFCV. If the battery voltage is not larger than the BFCV, no adjustment to the BFCV is made and the method continues with the seventh step S107. If, however, the battery voltage at least corresponds to the BFCV (second criterion), then the BFCV is increased, provided that all other criteria are also fulfilled. The third criterion, which is checked in step S110, is that the accumulated charge AC is less than the desired device capacity DDC (set in the second step S102). If the accumulated charge AC is equal or larger than the desired device capacity DDC, then no adjustment is made to the BFCV and the method continues with the seventh step S107. If, however, the accumulated charge AC is smaller than the desired device capacity DDC (third criterion), then the BFCV is increased, provided that all other criteria are also fulfilled. The ninth and tenth step S109, S110 may be executed in any order or in parallel.

The seventh, eighth, ninth and tenth step S107-S110 as described above are particular to the regular flat charging. For linear and non-linear charging these steps S107-S110 are replaced by different steps S207-S209 and S303-S305 achieving the same effect, namely, to increase the BFCV after a last charging phase and for a next charging phase such that a minimum capacity of the battery 6 is maintained.

If all three criteria mentioned above are fulfilled, an eleventh step S111 is executed, in which the BFCV is adjusted by adding the BFCV increment BFCV_inc. In a twelfth step S112, the BFCV is limited to the FBFCV. To do so, the BFCV is set to the FBFCV if the BFCV calculated in the eleventh step S111 is larger than the FBFCV. After the eleventh step S111 and the twelfth step S112, a discharging phase occurs and the method returns to the seventh step S107 for the next charging phase.

Referring now to FIGS. 5 and 6, the cycle count may be monitored instead and the BFCV is, then, increased after a predefined number of cycles instead of monitoring the accumulated charge AC as described above in connection with the regular flat charging. The cycle count is the number of cycles that has elapsed since the initial starting of the device 2. The cycle count is an integer that represents the number of completed cycles and, correspondingly, the number of completed charging phases. In the examples shown here, the cycle count is incremented by 1 only when the battery 6 in the device 2 has completed a charging phase to a pre-defined charging capacity level and/or has depleted during a discharging phase to a pre-defined capacity level.

An embodiment of the linear flat charging method is shown in FIG. 5. In this example, a cycle count interval cc_int is set during pre-processing P1 and the BFCV is increased every time the count number finishes the cycle count interval cc_int, as illustrated in step S209 (the same applies to step S305 in FIG. 6).

In the pre-processing stage P1 of the linear flat charging method according to FIG. 5, an IBFCV and an FBFCV are set in a first and second step S201, S202, respectively, the same as in the third and fourth step S103, S104 of the regular flat charging method. Also in the pre-processing stage P1 a BFCV increment BFCV_inc is set (corresponding to the fifth step S105 of the regular flat charging method) to be used in the in-processing stage P2 to adjust the BFCV. This is realized in a third and fourth step S203, S204 of the pre-processing P1: In the third step S203 a number of levels n of the BFCV between the IBFCV and the FBFCV is set. Then, in the fourth step S204 the BFCV increment BFCV_inc is calculated based on the levels, the FBFCV and the IBFCV and set accordingly. The third and fourth step S203, S204 may also be reversed or the BFCV increment BFCV_inc may simply be set to a specific, pre-defined value.

In a fifth step S205 the cycle count interval cc_int for adjusting the BFCV is set. The cycle count interval cc_int is calculated from a lifespan requirement of the device 2 and an assumed average cycle number per unit time. In a sixth step S206 a counter k indicating the cycle count interval number is set to an initial value of 1. The counter k, then, corresponds to the number of elapsed cycle count intervals plus 1 and, thereby, indicates the number of the current cycle count interval cc_int as well as the BFCV level number currently used. However, this is just an example and the counter k and how it counts the cycle count intervals may defined differently in other embodiments of the invention.

In principle, the first to sixth step S201-S206 of the pre-processing P1 of the linear flat charging method as described above can be executed in any order.

In the example of FIG. 5, the BFCV during the in-processing P2 is increased in fixed steps corresponding to the BFCV increment BFCV_inc.

During step S208 of the in-processing stage P2 the cycle count is monitored by the charging controller 10 (the same applies to step S303 in FIG. 6). The BFCV remains unchanged while the cycle count is within the cycle count interval cc_int. The BFCV is only adjusted if the cycle count corresponds to the cycle count interval cc_int, i.e., if the cycle count divided by the cycle count interval cc_int yields an integer value. In addition, the BFCV remains unchanged regardless of the cycle count, once the cycle count reaches a saturation cycle count, which corresponds to an expected lifetime of the device 2. In the example described here, the saturation cycle count is calculated via ((k−1)×cc_int)+1, wherein k is the cycle count interval number, corresponding to the BFCV level number.

In the embodiment of FIG. 5 the in-processing P2 of the linear flat charging method is realized with a seventh to eleventh step S207-S211 as described in the following. In the seventh step S207 the BFCV is set based on the IBFCV, which serves as an offset, and the cycle count interval number k as well as the BFCV increment BFCV_inc. In the eight step S208, the cycle count is monitored and increased every time a charging phase is completed, wherein the criterion for considering a charging phase as complete is the same as already mentioned above. In the ninth step S209, the cycle count is compared to the cycle count interval cc_int. If the cycle count is larger than the cycle count interval cc_int times the cycle count interval number k, then, in the tenth step S210, the cycle count interval number k is increased by 1. Otherwise, the method continues with the eight step S208 and the BFCV is not increased for the next charging phase. Increasing the cycle count interval number k in the tenth step s110 every time the cycle count corresponds to the cycle count interval cc_int effectively increases the BFCV due to the cycle count interval number k being used for calculating the BFCV in the seventh step S207. In the eleventh step S111, then, a limitation of the BFCV occurs by maintaining the cycle count interval number k at a maximum cycle count interval number corresponding to the number of levels n.

The linear flat charging method can be further modified by not setting a fixed number for the cycle count interval cc_int and/or for the BFCV increment BFCV_inc. Instead, a different mapping of the cycle count to the BFCV is chosen. While the fixed cycle count interval cc_int and the fixed BFCV increment BFCV_inc in FIGS. 4 and 5 yield a linear behavior of adjusting the BFCV, any deviation from this yields a non-linear behavior. A corresponding method is denoted as non-linear charging method, an example of which is shown in FIG. 6. The cycle counts for which the BFCV is adjusted and/or the BFCV increment BFCV_inc used for the adjustment vary from adjustment to adjustment and, in principle, can be set to any value. In FIG. 6, a mapping of the cycle count to a specific BFCV or BFCV increment BFCV_inc is provided as a lookup table 18, in which a specific BFCV or BFCV increment BFCV_inc is given for each of a number of cycle counts. During in-processing, once the cycle count reaches a cycle count from the look-up table the corresponding BFCV or BFCV increment BFCV_inc is used to adjust the BFCV accordingly. The mapping may assign a respective BFCV to each or only some cycles.

In the embodiment shown in FIG. 6, the non-linear flat charging method comprises a first step S301, in which the look-up table 18 as described is provided. The look-up table 18 here maps cycle count numbers cc_k (cc_1 to cc_n) to a respective BFCV_k (BFCV_1 to BFCV_n). In a second step S302, a counter k used during in-processing P2 to monitor the number of elapsed cycle intervals is set to 1. The first and second step S301, SS302 are part of the pre-processing P1 of the non-linear flat charging method. During the subsequent in-processing stage P2, the look-up table 18 is used to increase the BFCV in order to maintain a desired minimum capacity. The method then comprises a third to seventh step S303-S307, which basically correspond to the seventh to eleventh step S207-S211 as discussed above in connection with the linear flat charging method. The differences are: in the third step S303, the BFCV is simply taken retrieved from the look-up table 18 according to the current cycle count number cc_k. In the fifth step S305, the cycle count is compared against the cycle count numbers cc_k in the look-up table 18. If the current cycle count number cc_k is present in the look-up table 18, the corresponding BFCV_k or BFCV increment BFCV_inc_k is used. This is achieved in FIG. 6 by comparing the cycle count against the cycle count numbers cc_k in the look-up table 18 and using the last BFCV_k for which the cycle count is larger than the corresponding cycle count number cc_k.

The various features mentioned in connection with either one of the regular flat charging method, linear flat charging method and non-linear flat charging method may, if possible, also be realized in the other methods. Also, any statements made in connection with one of the methods analogously apply to the other methods.

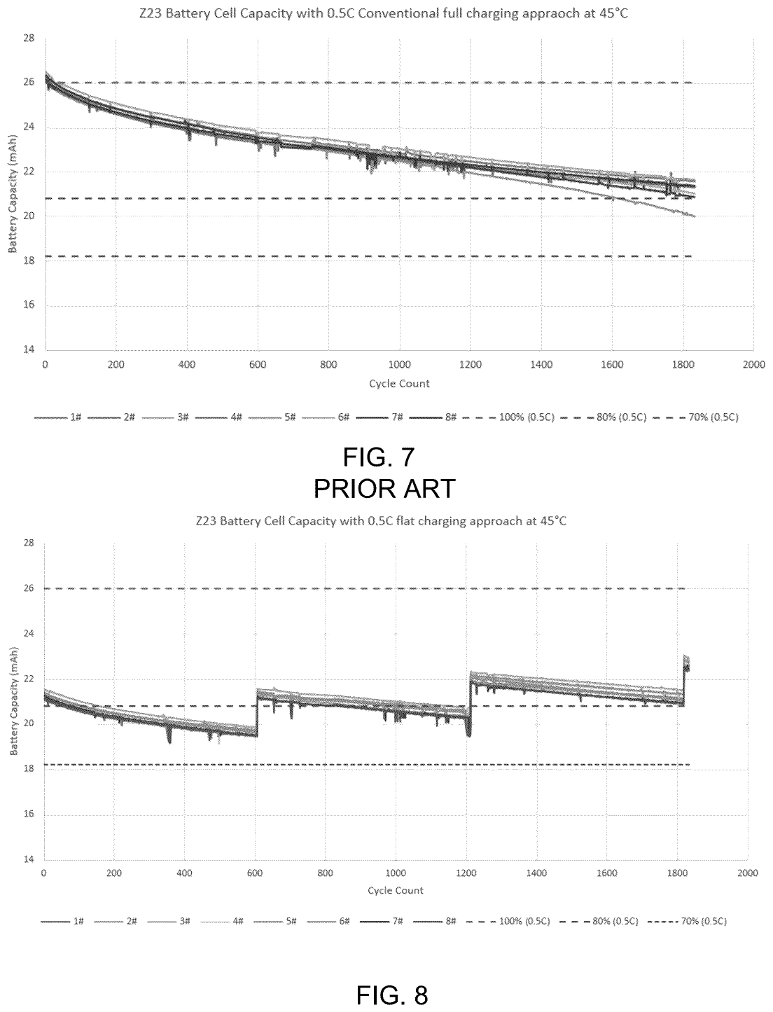

FIGS. 7 and 8 each show an exemplary battery life cycle plot as a result of a battery life cycle test for a typical full charging method (FIG. 7) and the inventive linear flat charging method (FIG. 8). In both figures, the battery's capacity is shown as a function of the cycle count. The cycle count for the life cycle test is expected to span five years of charging cycles with one cycle per day and at least 70% remaining battery capacity after the five years. The BFCV for the typical full charging method is set to a constant 4.2V and remains unchanged throughout the entire life cycle. The cycle count interval cc_int of linear flat charging method is set to 606, and the respective BFCV for the linear flat charging method is set according to Table 3 as follows:

TABLE 3

| Cycle count | | |
|---|---|---|
| interval number (k) | Cycle count | BFCV |
| 1 | 1-606 | 4.05 V |
| 2 | 607-1212 | 4.10 V |
| 3 | 1213-1818 | 4.15 V |
| 4 | ≥1819 | 4.20 V |

The BFCV is adjusted with a BFCV increment of 0.05V at a cycle count interval cc_int of 606 cycles. The life cycle test is carried out for both charging methods with continuous charge and discharge phases up to a cycle count of 1833 cycles, which is equivalent to 5 years and 8 days. The capacity of the battery 6 is recorded for every cycle.

The capacity of the battery 6 using the typical full charging method (FIG. 7) continuously drops over time with increasing cycle count. On the other hand, the battery capacity using the linear flat charging method also drops over time but experiences sudden rises at cycles 607, 1213, and 1819 due to the adjustment of the BFCV at these cycles. The test results indicate that the initial battery capacity using the linear flat charging method is about 21.5 mAH, which is lower than the typical full charging method with a fully charged battery capacity of about 26 mAH. The linear flat charging method sacrifices the high initial battery capacity, but over time is able to maintain a certain minimum capacity.

Overall, the battery capacity when using the linear flat charging method is higher than the capacity when using the typical full charging method at the 1833^{rd} cycle. FIGS. 7 and 8 each show the capacity as a function of the cycle count for eight battery samples. The average battery capacity of the eight samples in the typical full charging method is 21.12 mAH (FIG. 7) and for the linear flat charging method is 22.53 mAH (FIG. 8) as indicated by a corresponding horizontal line in each figure and as listed in the following Table 4.

TABLE 4
(i)

| | Battery Capacity (mAh) at | Battery Capacity (mAh) at |
|---|---|---|
| Battery | cycle no. 1833 when using a | cycle no. 1833 then using |
| sample | typical full charging method | the linear flat charging |
| no. | (FIG. 7) | method (FIG. 8) |
| 1 | 21.57 | 22.53 |
| 2 | 21.23 | 22.52 |
| 3 | 21.65 | 22.51 |
| 4 | 21.31 | 22.74 |
| 5 | 19.97 | 22.75 |
| 6 | 21.02 | 22.41 |
| 7 | 20.86 | 22.43 |
| 8 | 21.36 | 22.34 |
| Average | 21.12 | 22.53 |

The higher battery capacity at the same cycle count implies a lower voltage stress applied to the battery 6 for the flat charging method. As a result, applying the flat charging method effectively prolongs the lifetime of the battery 6 in the device 2 and reduces the degradation of the battery 6 with the result of reduced capacity fading.

The following is a summary list of reference numerals and the corresponding structure used in the above description of the invention:
2 device
4 charger
6 battery
8 control unit
10 charging controller
12 input transducer
14 signal processing unit
16 output transducer
18 look-up table
AC accumulated charge
BFCV (current) battery fully charged voltage
BFCV_inc battery full charging voltage increment
BSCV_lim start charging battery voltage limit
cc_int cycle count interval
cc_k cycle count number
DDC desired device capacity
FBFCV final battery fully charged voltage
IBFCV initial battery fully charged voltage
k counter, cycle count interval number, BFCV level number
n number of levels
P1 pre-processing
P2 in-processing

1. A method for charging a battery of a device, which comprises the steps of:
setting an initial battery fully charged voltage (BFCV), which after completion of a charging phase yields a capacity less than a maximum capacity of the battery;
charging, in each of several charging phases, the battery until a charging voltage of the battery reaches a current BFCV;
setting, for a first of the charging phases, the current BFCV to the initial BFCV; and
increasing the current BFCV after a last charging phase and for a next charging phase such that a minimum capacity of the battery is maintained.

2. The method according to claim 1, which further comprises increasing the current BFCV for the next charging phase if an accumulated charge acquired during the last charging phase is lower than a predefined desired device capacity.

3. The method according to claim 1, which further comprises increasing the current BFCV for the next charging phase if:
a start charging battery voltage of the last charging phase is lower than a predefined start charging battery voltage limit; and
an end charging battery voltage of the last charging phase is larger than or equal to the BFCV; and
an accumulated charge acquired during the last charging phase is less than a predefined desired device capacity.

4. The method according to claim 1, which further comprises:
increasing a cycle count every time a charging phase is completed; and
increasing the current BFCV for the next charging phase, if the cycle count reaches one of a plurality of predefined cycle numbers.

5. The method according to claim 4, which further comprises defining the predefined cycle numbers by a fixed cycle-count interval, such that the current BFCV is increased every time a fixed number of the charging phases corresponding to the fixed cycle-count interval is completed.

6. The method according to claim 1, which further comprises:
increasing a cycle count every time a charging phase is completed; and
increasing the current BFCV based on a current cycle count according to a look-up table.

7. The method according to claim 1, which further comprises if the current BFCV is increased, it is increased by a predefined BFCV increment.

8. The method according to claim 1, wherein the increasing of the current BFCV is limited to a predefined final BFCV.

9. The method according to claim 1, wherein the device is a hearing aid and the battery is a secondary battery.

10. A device configured for carrying out the method according to claim 1.

11. A non-transitory computer program product having computer executable instruction which when executed by a device, cause said device to perform a method for charging a battery of the device, which comprises the steps of:
setting an initial battery fully charged voltage (BFCV), which after completion of a charging phase yields a capacity less than a maximum capacity of the battery;
charging, in each of several charging phases, the battery until a charging voltage of the battery reaches a current BFCV;
setting, for a first of the charging phases, the current BFCV to the initial BFCV; and
increasing the current BFCV after a last charging phase and for a next charging phase such that a minimum capacity of the battery is maintained.
